(19) United States
(12) Patent Application Publication
(10) Pub. No.: US 2011/0065496 A1
(43) Pub. Date: Mar. 17, 2011

(54) AUGMENTED REALITY MECHANISM FOR WAGERING GAME SYSTEMS

(75) Inventors: Mark B. Gagner, West Chicago, IL (US); Joel R. Jaffe, Glenview, IL (US); Victor T. Shi, Morton Grove, IL (US); Craig J. Sylla, Round Lake, IL (US); Matthew J. Ward, Northbrook, IL (US)

(73) Assignee: WMS Gaming, Inc., Waukegan, IL (US)

(21) Appl. No.: 12/879,932

(22) Filed: Sep. 10, 2010

Related U.S. Application Data
(60) Provisional application No. 61/241,599, filed on Sep. 11, 2009.

(51) Int. Cl. A63F 9/24; A63F 13/00

(52) U.S. Cl. 463/25; 463/30; 463/43

(57) ABSTRACT

A wagering game system and its operations are described herein. In some embodiments, the operations can include detecting, at a gaming machine, a fiducial marker in one or more images captured by an image capture device of the gaming machine, determining an orientation of the fiducial marker, and detecting a fiducial code embedded within the fiducial marker. The operations can also include providing, via a network, fiducial code information and fiducial marker orientation information to a wagering game server to identify an augmented reality object associated with the fiducial code and determine attributes of the augmented reality object. The operations can further include receiving, at the gaming machine, wagering game content and the augmented reality object from the wagering game server, incorporating the augmented reality object within the wagering game content, and presenting the wagering game content comprising the augmented reality object on a display device of the gaming machine.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2010, WMS Gaming, Inc.

### FIELD

Embodiments of the inventive subject matter relate generally to wagering game systems, and more particularly to augmented reality mechanisms for wagering game systems.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

Traditionally, wagering game machines have been confined to physical buildings, like casinos (e.g., major casinos, road-side casinos, etc.). The casinos are located in specific geographic locations that are authorized to present wagering games to casino patrons. However, with the proliferation of interest and use of the Internet, some wagering game manufacturers have recognized that a global public network, such as the Internet, can reach to various locations of the world that have been authorized to present wagering games. Consequently, some wagering game manufacturers have created wagering games that can be processed by personal computing devices and offered via online casino websites (“online casinos”).

### BRIEF DESCRIPTION OF THE FIGURES

Embodiments of the inventive subject matter are illustrated in the Figures of the accompanying drawings in which:

FIG. 1 is a conceptual diagram illustrating an example of implementing augmented reality in a wagering game system, according to some embodiments;

FIG. 2 is a conceptual diagram illustrating an example of using a fiducial marker to control various attributes of an augmented reality object, according to some embodiments;

FIG. 3 is a conceptual diagram illustrating another example of implementing augmented reality in a wagering game system, according to some embodiments;

FIG. 4 is a conceptual diagram illustrating another example of implementing augmented reality in a wagering game system, according to some embodiments;

FIG. 5 is a conceptual diagram that illustrates an example of a wagering game system architecture, according to some embodiments;

FIG. 6 is a flow diagram illustrating operations for providing a fiducial marker to a player in a wagering game system, according to some embodiments;

FIG. 7 is a flow diagram illustrating operations for implementing augmented reality in a wagering game system, according to some embodiments;

FIG. 8 is a flow diagram illustrating operations for implementing augmented reality in a wagering game system, according to some embodiments;

FIG. 9 is a flow diagram illustrating operations for using the fiducial marker and the augmented reality object to interact with the wagering game content in a wagering game system, according to some embodiments;

FIG. 10 is a conceptual diagram that illustrates an example of a wagering game machine architecture, according to some embodiments; and

FIG. 11 is a perspective view of a wagering game machine, according to example embodiments.

### DESCRIPTION OF THE EMBODIMENTS

This description of the embodiments is divided into five sections. The first section provides an introduction to some embodiments, while the second section describes example wagering game machine architectures. The third section describes example operations performed by some embodiments and the fourth section describes example wagering game machines in more detail. The fifth section presents some general comments.

### Introduction

This section provides an introduction to some embodiments.

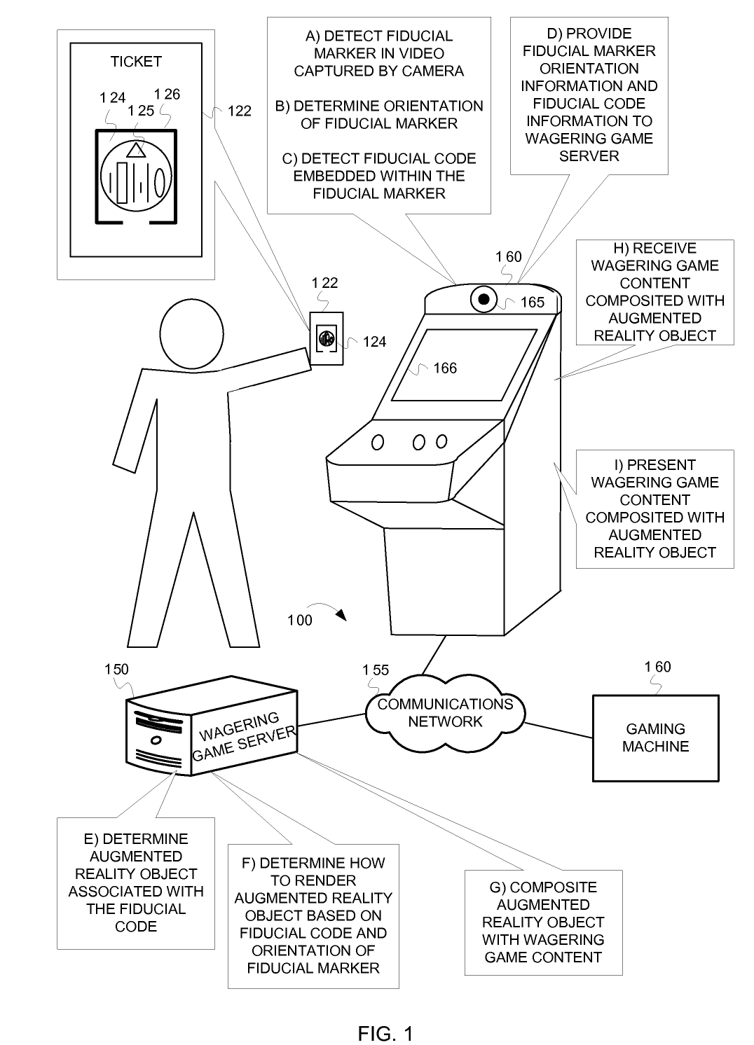

Wagering game systems offer wagering game players (“players”) entertainment value and the opportunity to win monetary value. In various embodiments, wagering game systems can try to enhance the gaming experience by incorporating augmented reality objects (e.g., two-dimensional (2D) or three-dimensional (3D) objects) within wagering games and allowing players to control one or more attributes of the augmented reality object during game play. In some instances, augmented reality can include the blending of computer-generated graphic objects into a live video stream. In some implementations, the wagering game system can use machine vision and image processing to detect a fiducial marker in a live video stream and render the augmented reality object according to the fiducial marker. Then, the wagering game system can composite wagering game content with the augmented reality object and offer wagering games that allow players to control one or more attributes of the augmented reality object during game play. In some examples, a fiducial marker can include a physical object, a one-dimensional (1D) code, and/or a two-dimensional (2D) code that may be used as a point of reference or a measure, e.g., for blending the augmented reality object within the live video stream, and also for encoding/decoding purposes, e.g., to identify which augmented reality object to render. In some implementations, the wagering game system can provide a fiducial marker to a player in various ways, e.g., a gaming machine can print a game ticket including the fiducial marker for the player, a wagering game server can email or text the fiducial marker to the player, etc. In one example, the player can use the fiducial marker to reveal an augmented reality 2D or 3D object within a wagering game, e.g., a wagering base game or a wagering bonus game, as will be further described below with reference to FIGS. 1-9. Furthermore, the player can use the fiducial marker to control various attributes of the augmented reality 2D or 3D object, e.g., control the movement, modify the orientation, change the composition, etc. during game play, as will be further described below in FIGS. 1-9. It is noted that additional examples of incorporating augmented reality in wagering games will be described below. It is further noted that the mechanism and techniques described herein for using augmented reality in wagering games can be implemented in both online wagering game systems and casino floor wagering game systems.

FIG. 1 is a conceptual diagram illustrating an example of implementing augmented reality in a wagering game system, according to some embodiments. In the example shown in FIG. 1, the wagering game system (“system”) 100 includes a wagering game server 150 connected to one or more wagering game machines (“gaming machines”) 160 via a communications network 155.

In one implementation, at stage A, the gaming machine 160 detects a fiducial marker in one or more images captured by a camera 165 of the gaming machine 160. In one example, a player positions a game ticket 122 (or other object) including a fiducial marker 124 in the field of vision of the camera 165. The camera 165 captures video of objects in the field of vision of the camera 165 including the game ticket 122 with the fiducial marker 124. In this example, an image processing mechanism of the gaming machine 160 detects the fiducial marker 124 on the game ticket 122 captured in the video. In one implementation, the fiducial marker 124 can include a fiducial code 125 and a bounding indicator 126. In some examples, the fiducial code 125 may include a 1D barcode, 2D barcode, geometric patterns, text, or a combination thereof, that can be used to identify which augmented reality object to render. The fiducial code 125 may also include additional metadata and other information associated with the fiducial marker, e.g., a serial number to track when the player uses the fiducial marker. In one example, the bounding indicator 126 may include a bounding square or similar indicator that surrounds the fiducial code 125 and helps to identify the location of the fiducial code 125. The bounding indicator 126 can also indicate the orientation of the fiducial marker 124, as will be further described below.

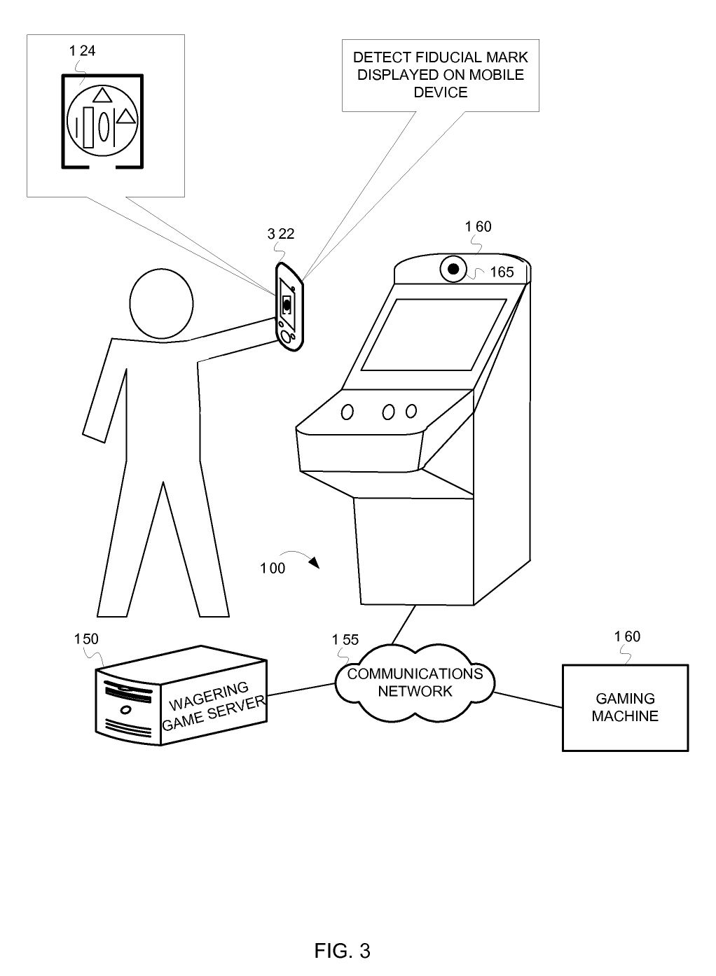

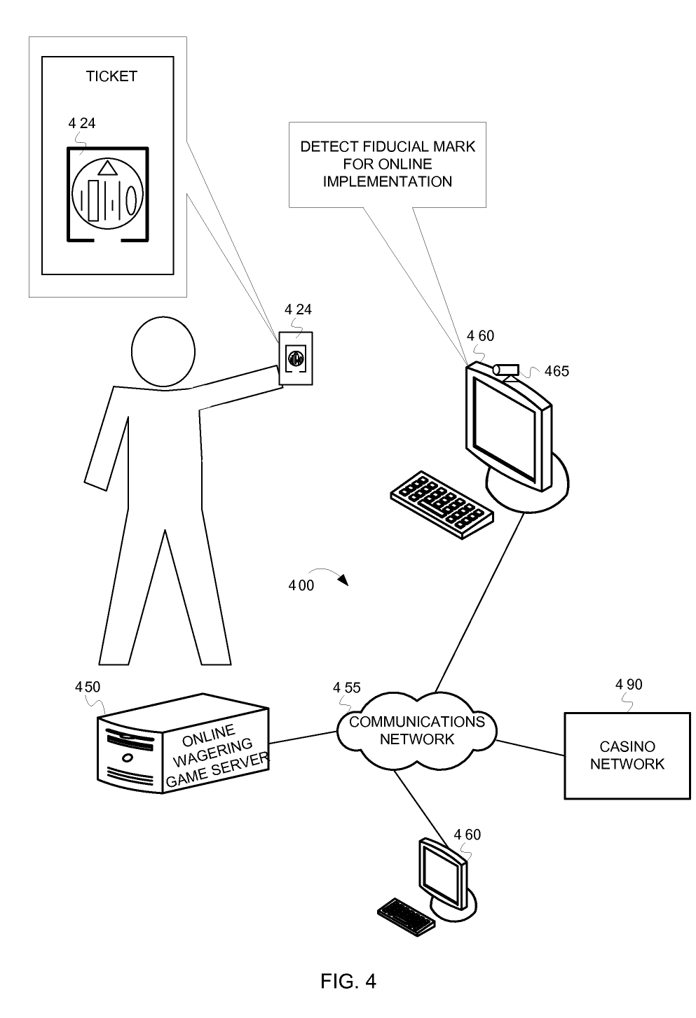

It is noted that in other implementations, the fiducial marker can be provided to the player and the fiducial marker can be presented to the camera by other methods, e.g., as shown in FIGS. 3 and 4. In the example of FIG. 3, the fiducial marker 124 can be emailed or text to the player and the player can present the fiducial marker 124 by positioning a mobile device 322 displaying the fiducial marker in the field of vision of the camera 165. The mobile device 322 can be various types of portable devices, e.g., a mobile phone, smart phone, a personal digital assistant (PDA), a media player, an electronic book reader, a netbook, etc. It is further noted that augmented reality can be implemented in online wagering game systems, e.g. as shown in FIG. 4, comprising an online wagering game server 450, a communication network 455, and a plurality of client gaming machines 460. In an online implementation, the player can position the fiducial marker 124 in front of a camera 465 (e.g, a webcam) of a gaming machine 460 so that the gaming machine 460 can detect and process the fiducial code. The gaming machines 460 can be various types of devices that can connect to the communication network 455 (e.g., the Internet) and incorporate machine vision (e.g., a webcam). For example, the gaming machines 460 can be a personal computer (PC), a laptop, a workstation, etc. In some implementations, the online wagering game system 400 can be tied to a casino network 490, e.g., to access player account information, to monitor and provide fiducial markers that can be used at either home or the casino, as will be further described below.

Returning to FIG. 1, at stage B, the gaming machine 160 determines the orientation of the fiducial marker 124. In one implementation, the image processing mechanism of the gaming machine 160 detects the bounding indicator 126 to determine the orientation of the fiducial marker 124. In one example, if the bounding indicator 126 includes a bounding square, the gaming machine 160 can determine the orientation of the fiducial marker 124 by performing measurements on the location of the corners of the square and the angles of the corners of the square. It is noted, however, that in other implementations the gaming machine 160 can determine the orientation of the fiducial marker 124 by other methods. For example, instead of having a separate bounding indicator 126 in the fiducial marker 124, the gaming machine 160 can use the fiducial code 125 and/or other metadata embedded within the fiducial marker 124 to determine the orientation of the fiducial marker 124.

At stage C, the gaming machine 160 detects the fiducial code 125 embedded within the fiducial marker 124. In one implementation, the image processing mechanism of the gaming machine 160 detects the fiducial code 125 within the fiducial marker 124 in one or more of the images captured by the camera 165. The fiducial code 125 can include any type of optical machine-readable code or representation of data, for example, a 1D code (e.g., linear barcode), a 2D code (e.g., a matrix of dots and geometric shapes), text, geometric patterns, etc. It is noted that in some examples the bounding indicator 126 can be a part of the fiducial code 125.

At stage D, the gaming machine 160 provides information indicating the fiducial marker orientation and information indicating the fiducial code 125 to the wagering game server 150 via the communications network 155.

At stage E, the wagering game server 150 receives the information indicating the fiducial code 125 and determines the augmented reality object associated with the fiducial code 125. For example, after recognizing the fiducial code 125 based on the information received from the gaming machine 160, the wagering game server 150 can access a database to determine which augmented reality 2D or 3D object is associated with the fiducial code 125.

At stage F, the wagering game server 150 determines how to render the augmented reality object based on the fiducial code 125 and the orientation of the fiducial marker 124. For example, metadata within the fiducial code 125 and/or the orientation of the fiducial marker 124 can determine attributes of an augmented reality 3D object, e.g., determine movement, orientation, composition, etc. of the augmented reality 3D object.

At stage G, the wagering game server 150 composites the augmented reality object with the wagering game content that is being provided to the gaming machine 160. In some instances, compositing can include combining visual elements from separate sources into single images, e.g., one or more images that comprise a video stream. In one implementation, the wagering game server 150 composites video of the fiducial marker 124 and the augmented reality object with the wagering game content. In some implementations, the wagering game server 150 uses the fiducial marker 124 as a reference point when performing the compositing operations. It is noted, however, that in other implementations the gaming machine 160 can be configured to perform the compositing operations. In these implementations, the wagering game server 150 can provide the wagering game content and the rendered augmented reality object to the gaming machine 160, and the gaming machine 160 can composite the video of the fiducial marker 124 and the augmented reality object with the wagering game content.

At stage H, the gaming machine 160 receives the wagering game content composited with the augmented reality object from the wagering game server 150 via the communications network 155.

At stage I, the gaming machine 160 presents the wagering game content composited with the augmented reality object on a display device 166 of the gaming machine 160.

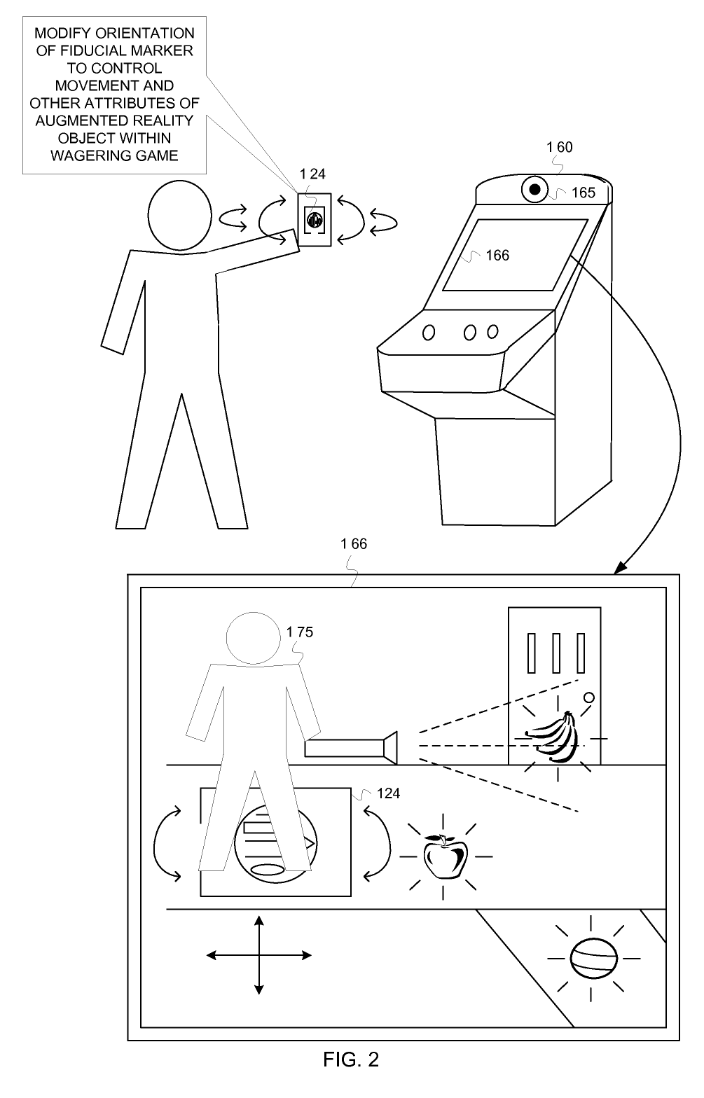

FIG. 2 is a conceptual diagram illustrating an example of using the fiducial marker 124 to control various attributes of an augmented reality 3D object, according to some embodiments. In the example shown in FIG. 2, during a wagering game session, the gaming machine 160 presents on the display device 166 wagering game content composited with video of the fiducial marker 124 and the associated augmented reality 3D object. In one implementation, the player can rotate, tilt, or otherwise change the orientation of the fiducial mark 124 (while the fiducial marker 124 is positioned in the field of vision of the camera 165) to control various attributes of the augmented reality 3D object during game play. For example, modifying the orientation of the fiducial marker 124 can control the movement, modify the orientation, change the composition, etc. of the augmented reality 3D object, and allow the player to interact with and play the wagering game. In the example of FIG. 2, the wagering game may be a secondary bonus game (e.g., a picking game) and the augmented reality 3D object is an avatar 175 holding a flashlight. In this example, modifying the orientation of the fiducial marker 124 can control the direction the avatar 175 walks within the game, control the direction the avatar 175 points the flashlight, change the orientation of the avatar 175 and flashlight with respect to the point of view of the player, control what other tools (besides the flashlight) the avatar 175 uses, controls other movements of the avatar 175 (e.g., opening doors), etc. It is noted that in other examples various types of augmented reality objects can be used to play various types of wagering games in a similar manner.

Although FIGS. 1-4 describes some embodiments, the following sections describe many other features and embodiments.

### Operating Environment

This section describes example operating environments and networks and presents structural aspects of some embodiments. More specifically, this section includes discussion about wagering game system architectures.

### Wagering Game System Architectures

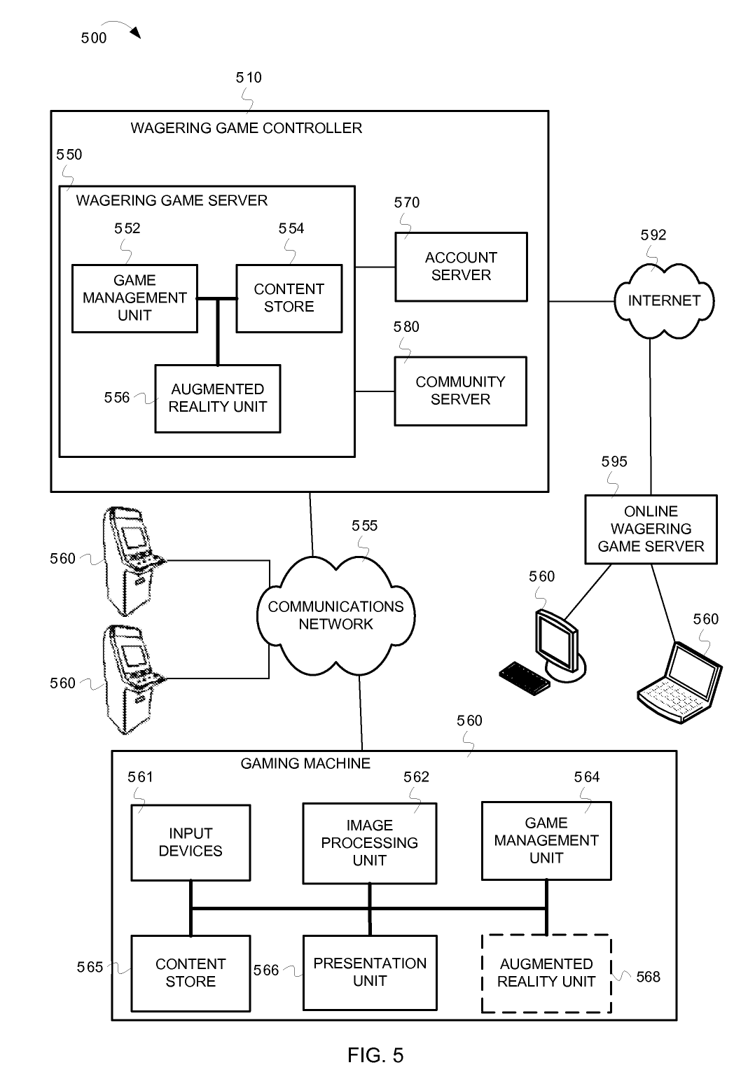

FIG. 5 is a conceptual diagram that illustrates an example of a wagering game system architecture 500, according to some embodiments. As illustrated, the wagering game system architecture 500 includes a wagering game controller 510 and a plurality of gaming machines 560. The wagering game controller 510 is configured to control game content (e.g., game elements and results) and communicate game-related information and other information (e.g., social networking services) to and from the plurality of gaming machines 560. In one embodiment, the wagering game controller 510 includes a wagering game server 550, an account server 570, and a community server 580. In some embodiments, the wagering game controller 510 may be configured to communicate with other systems, devices, and networks. For example, the wagering game controller 510 may be configured to communication with one or more additional casinos, and/or an online wagering game server 595 of an online casino network.

The wagering game server 550 is configured to manage and control content for presentation on the gaming machines 560. For example, the wagering game server 550 includes a game management unit 552 configured to provide (e.g., stream) game content and other game-related information to the gaming machines 560 during a wagering game session. The game management unit 552 is configured to generate (e.g., using a random numbers generator) game results (e.g., win/loss values), including win amounts, for wagering games played on the gaming machines 560. The game management unit 552 can communicate the game results to the gaming machines 560 via the network 555. In some implementations, the game management unit 552 can also generate random numbers and provide them to the gaming machines 560 so that the gaming machines 560 can generate game results. The wagering game server 550 can also include a content store 554 configured to store content used for presenting wagering games (e.g., base wagering games, secondary bonus games, etc.) and other information on the gaming machines 560. The wagering game server 550 can also include an augmented reality unit 556 configured to communicate with the gaming machines 560 (e.g., receive fiducial marker information), identify augmented reality objects associated fiducial markers, render augmented reality objects, composite the augmented reality objects with wagering game content, and other operations to implement augmented reality within the wagering game system 500 (see FIGS. 1-9).

The account server 570 is configured to control player-related accounts accessible via the wagering game system 500. The account server 570 can manage player financial accounts (e.g., performing funds transfers, deposits, withdrawals, etc.) and player information (e.g., avatars, screen name, account identification numbers, social contacts, financial information, etc.). The account server 570 can also provide auditing capabilities, according to regulatory rules, and track the performance of players, machines, and servers. The account server 570 can include an account controller configured to control information for player accounts. The account server 570 can also include an account store configured to store information for player accounts.

The community server 580 is configured to provide a wide range of services to members of virtual gaming communities. For example, the community servers may allow players to:
Create Social Networks—When creating social networks, members can create electronic associations that inform network members when selected members are: 1) online, 2) performing activities, 3) reaching milestones, 4) etc.
Establish a Reputation—Community members can establish reputations based on feedback from other community members, based on accomplishments in the community, based on who is in their social network, etc.
Provide Content—Community members can provide content by uploading media, designing wagering games, maintaining blogs, etc.
Filter Content—Community members can filter content by rating content, commenting on content, or otherwise distinguishing content.
Interact with Other Members—Community members can interact via newsgroups, e-mail, discussion boards, instant messaging, etc.
Participate in Community Activities—Community members can participate in community activities, such as multi-player games, interactive meetings, discussion groups, real-life meetings, etc.
Connect Casino Players to Online Members—Community members who are playing in casinos can interact with members who are online. For example, online members may be able to: see activities of social contacts in the casino, chat with casino players, participate in community games involving casino players, etc.

In some embodiments, the community server 580 enables online community members (e.g., operating a personal computer (PC) or a mobile device) to participate in and/or monitor wagering games that are being presented in one or more casinos. The community server 580 can enable community members to connect with and track each other. For example, the community server 580 can enable community members to select other members to be part of a social network. The community server 580 can also enable members of a social network to track what other social network members are doing in a virtual gaming community and a real-world casino. For example, in some implementations, the community server 580 assists in enabling members of a social network to see when network members are playing wagering game tables and machines in a casino, accessing a virtual gaming community web site, achieving milestones (e.g., winning large wagers in a casino), etc.

The community server 580 can store and manage content for a virtual gaming community. For example, in some embodiments, the community server 580 can host a web site for a virtual gaming community. Additionally, the community server 580 can enable community members and administrators to add, delete, and/or modify content for virtual gaming communities. For example, the community server 580 can enable community members to post media files, member-designed games, commentaries, etc., all for consumption by members of a virtual gaming community.

The community server 580 can track behavior of community members. In some embodiments, the community server 580 tracks how individuals and/or groups use the services and content available in a virtual gaming community. The community server 580 can analyze member behavior and categorize community members based on their behavior. The community server 580 can configure network components to customize content based on individual and/or group habits.

The community server 580 can manage various promotions offered to members of a virtual gaming community. For example, the promotions community server 580 can distribute promotional material when members achieve certain accomplishments (e.g., scores for online games) in a virtual gaming community. Members may use some of the promotional material when playing wagering games in a casino. For example, fiducial markers can be distributed to the members of the virtual gaming community.

The gaming machines 560 are configured to present wagering games and receive and transmit information to control the content that is presented for the wagering games. The gaming machines 560 can include input devices 561, an image processing unit 562, a wagering game unit 564, a content store 565, and a presentation unit 566. In some embodiments, the gaming machine 560 can also include an augmented reality unit 568. The input devices 561 may include buttons, joysticks, touch screens, cameras (e.g., camera 165 of FIG. 1), etc., used by players to provide and capture player input. The image processing unit 562 is configured to detect a fiducial marker in one or more of the images captured by the camera 165, determine the orientation of the fiducial marker, detect a fiducial code within the fiducial marker, and otherwise process the fiducial marker as described herein. The wagering game unit 564 is configured to manage and control the game content that is presented on the gaming machine 560. The wagering game unit 564 can also generate game results based on random numbers received from the wagering game server 550, or may communicate with the wagering game server 550 to obtain the game results. The content store 565 is configured to store content that is presented on the wagering game machine 560. The presentation unit 566 is configured to control the presentation of the game content on the wagering game machine 560. The presentation unit 566 can include one or more browsers and any other software and/or hardware suitable for presenting audio and video content. It is noted, however, that in other implementations the game content can be presented using other display technologies. In some embodiments, the gaming machine 560 can include the augmented reality unit 568 configured to receive wagering game content and the rendered augmented reality object from the wagering game server 550, and composite the video of the fiducial marker 124 and the augmented reality object with the wagering game content.

In some embodiments, each of the gaming machines 560 and the wagering game server 550 are configured to work together such that the gaming machine 560 can be operated as a thin, thick, or intermediate client. For example, one or more elements of game play may be controlled by the gaming machine 560 (client) or the wagering game server 550 (server). Game play elements can include executable game code, lookup tables, configuration files, game results, audio or visual representations of the game, game assets or the like. In a thin-client example, the wagering game server 550 can perform functions such as determining game results or managing assets, while the gaming machine 560 can present a audible/graphical representation of such outcome or asset modification to the players. In a thick-client example, the gaming machine 560 can determine game outcomes and communicate the outcomes to the wagering game server 550 for recording or managing a player's account. Furthermore, in some implementations, the compositing operations can be performed at the wagering game server 550 and, in other implementations, the compositing operations can be performed at the gaming machine 560.

As described above, the wagering game system architecture 200 can include an online wagering game server 595 and a plurality of online gaming machines 560. The online gaming machines 560 can be various types of systems that are configured to connect to the Internet 592, e.g., a personal computer (PC), a mobile device, a laptop computer, a netbook, etc. Similar to the casino wagering game server 550, the online wagering game server 595 can include a content store, a game management unit, and an augmented reality unit. The online wagering game server 595 can be configured to work in conjunction with the online gaming machines 560 to incorporate augmented reality objects within wagering games of the online wagering game system, allow online players to control one or more attributes of the augmented reality object during game play, and perform the operations described herein with reference to FIGS. 1-9.

Each component shown in the wagering game system architecture 500 is shown as a separate and distinct element connected via a communications network 555. However, some functions performed by one component could be performed by other components. For example, the wagering game server 550 can be configured to perform some or all of the functions of the account server 570, and/or the game management unit 552 can be configured to perform some or all of the functions of the augmented reality unit 556. Furthermore, the components shown may all be contained in one device, but some, or all, may be included in, or performed by multiple devices, as in the configurations shown in FIG. 5 or other configurations not shown, e.g., the augmented reality unit can be distributed across the wagering game server 550 and the gaming machines 560. Furthermore, the wagering game system architecture 500 can be implemented as software, hardware, any combination thereof, or other forms of embodiments not listed. For example, any of the network components (e.g., the wagering game tables, machines, servers, etc.) can include hardware and machine-readable media including instructions for performing the operations described herein. Machine-readable media includes any mechanism that provides (i.e., stores and/or transmits) information in a form readable by a machine (e.g., a wagering game table, machine, computer, etc.). For example, tangible machine-readable storage media includes read only memory (ROM), random access memory (RAM), magnetic disk storage media, optical storage media, flash memory machines, and other types of tangible storage medium suitable for storing instructions. Machine-readable transmission media also includes any media suitable for transmitting software over a network.

Although FIG. 5 describes some embodiments, the following sections describe many other features and embodiments.

### Example Operations

This section describes operations associated with some embodiments. In the discussion below, the flow diagrams will be described with reference to the block diagrams presented above. However, in some embodiments, the operations can be performed by logic not described in the block diagrams.

In certain embodiments, the operations can be performed by executing instructions residing on machine-readable storage media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown in any flow diagram.

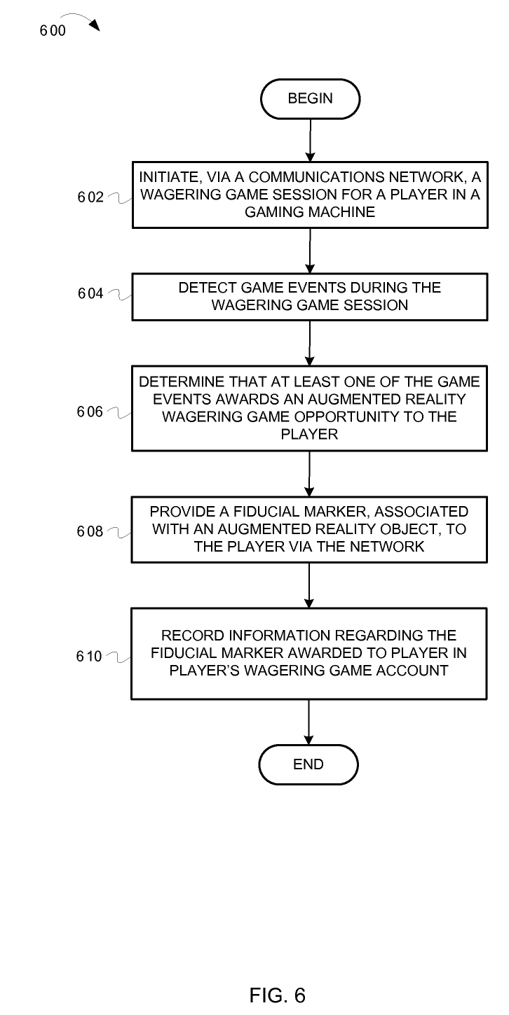

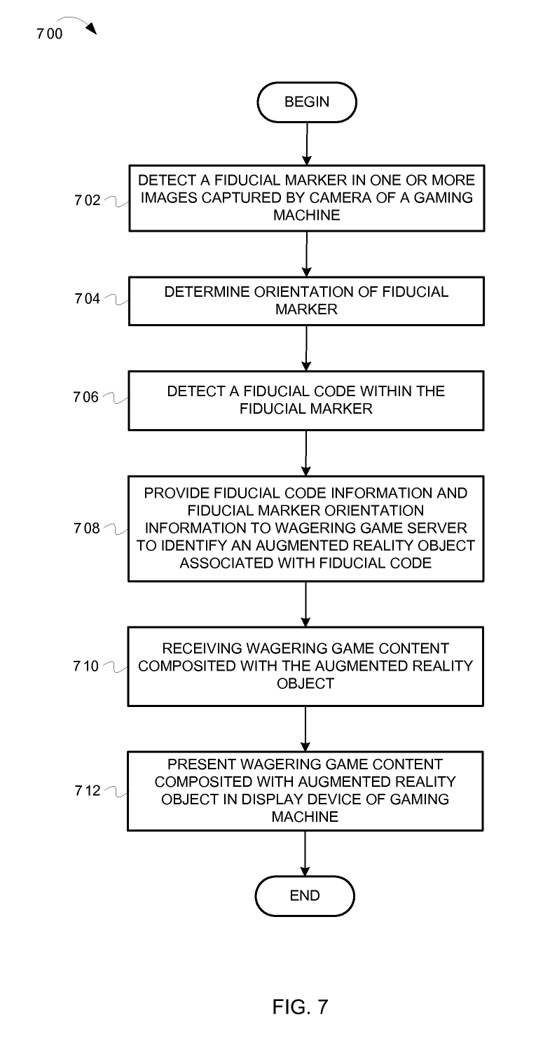

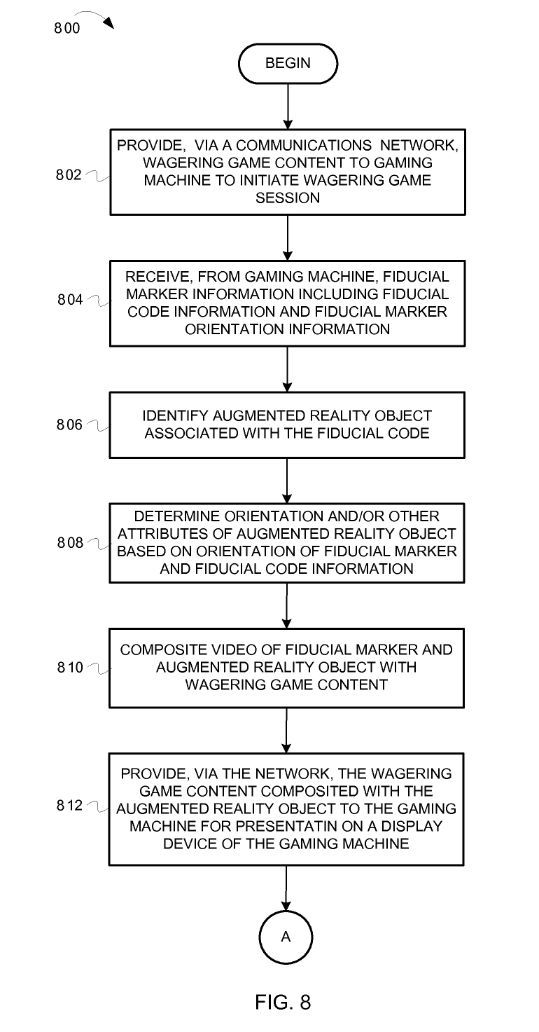

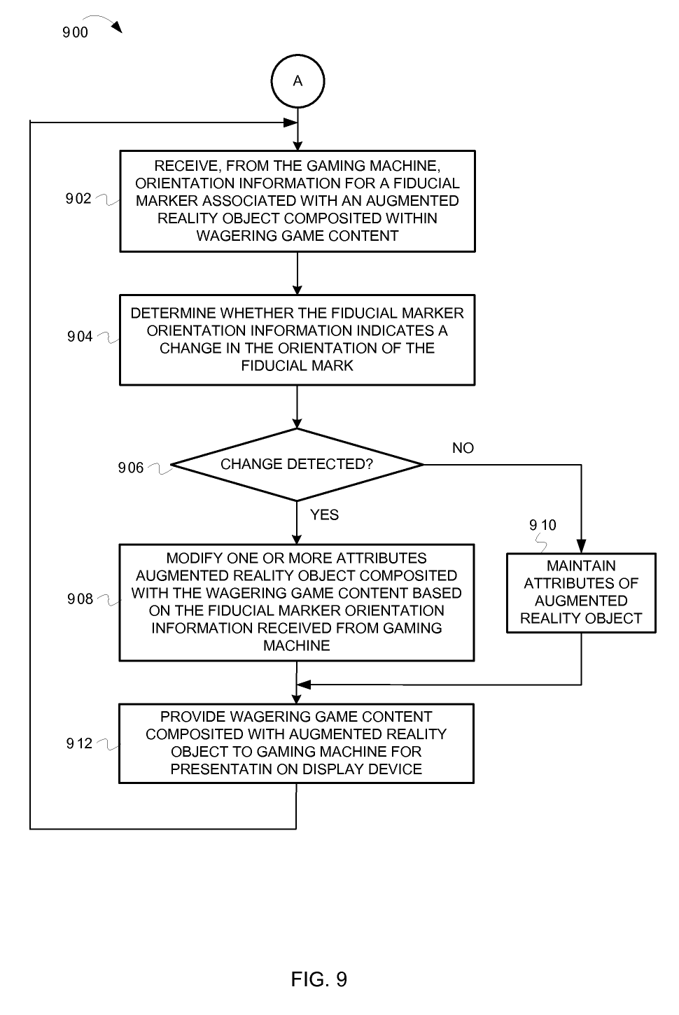

The following discussion of FIG. 6 describes example mechanisms for providing a fiducial marker to players. FIGS. 7-8 describe an example mechanism for implementing augmented reality in a wagering game system. FIG. 9 describes an example mechanism for using the fiducial marker and the augmented reality object to interact with the wagering game content in a wagering game system.

FIG. 6 is a flow diagram (“flow”) 600 illustrating operations for providing a fiducial marker to a player in a wagering game system, according to some embodiments. The flow of 600 will be described with reference to the example system architecture of FIG. 5. The flow diagram begins at block 602.

At block 602, the wagering game server 550 initiates, via a communications network 555, a wagering game session for a player in a display device of a gaming machine 560. For example, the game management unit 552 provides wagering game content and other game-related information to the gaming machine 560, and the gaming machine 560 presents the wagering games on the display device. After block 602, the flow continues at block 604.

At block 604, the wagering game server 550 detects game events associated with the wagering games that are played during the wagering game session. For example, the game management unit 552 detects game events such as game-related player inputs (e.g., max bets, base game player selections, bonus game player selections, etc.), game-related player account data (e.g., number of games played, player account balance, etc.), intermediate game results, final game results, etc. After block 604, the flow continues at block 606.

At block 606, the wagering game server 550 determines that at least one of the game events awards an augmented reality wagering game opportunity to the player. For example, the augmented reality unit 556 determines that a game event, e.g., a predefined number of max bets, a final game result that is above a predefined amount, etc., earns the player an augmented reality wagering game opportunity. In some implementations, the augmented reality wagering game opportunity can offer the player a chance to play a wagering game that incorporates augmented reality, as will be further described below. After block 606, the flow continues at block 608.

At block 608, in response to awarding the augmented reality wagering game opportunity to the player, the wagering game server 550 provides a fiducial marker, associated with an augmented reality object, to the player via the communications network 555. In one implementation, the augmented reality unit 556 determines the fiducial marker based on the augmented reality wagering game opportunity awarded to the player, and provides the fiducial marker to the player via the network 555. For example, the augmented reality unit 556 provides information about the fiducial marker to the gaming machine 560 via the network 555, and the gaming machine 560 prints the fiducial marker for the player, e.g., prints a game ticket comprising the fiducial marker. In another example, the augmented reality unit 556 causes the wagering game server 550 to email or text the fiducial marker to the player. For example, the wagering game server 550 can access the player's wagering game account in the account server 570 to obtain the player's email address or mobile phone number in order to send the fiducial marker to the player.

In one example, the fiducial marker provided to the player can be used in one or more of the wagering games that are available in the gaming machine 560 the player is currently playing. In another example, the fiducial marker is specific for a wagering game that is available at another gaming machine 560 within the casino. In this example, the casino operator can use the augmented reality wagering game opportunity to promote a new game or bring player traffic to existing games. In other examples, the fiducial marker is specific for a wagering game that is available at an online casino only. In this example, the casino operator can use the augmented reality wagering game opportunity to drive player traffic to the online casino. In some implementations, the online wagering game server 595 is also configured to provide fiducial markers to players similarly as described above. The fiducial markers provided by the online wagering game server 595 can also be used to drive player traffic to the online casino or to the brick and mortar casino. In some implementations, casino operators can incorporate fiducial markers into a marketing campaign to increase player traffic at a casino floor or online casino. For example, fiducial markers can be provided (e.g., via mail, email, text, etc.) to players that have spent a significant amount of time and/or money at the casino, players that have wagering game accounts with certain characteristics (e.g., number of games played, frequency of casino visits, types of games played, etc.), players that have booked a room at a casino in the near future, etc. After block 608, the flow continues at block 610.

At block 610, the wagering game server 550 records information regarding the fiducial marker awarded to the player in the player's wagering game account. For example, the augmented reality unit 556 records (e.g., at the account server 570) the type of fiducial marker that was awarded, and the wagering games that the fiducial marker can be used at in the casino. It is noted that other information associated with the fiducial marker can be stored in the player's account, e.g., security information such as a serial number that is embedded within the fiducial marker (or other identification information) that can be used to identify the fiducial marker and to limit the number of times the fiducial marker is used by the player. After block 610, the flow ends.

FIG. 7 is a flow diagram (“flow”) 700 illustrating operations for implementing augmented reality in a wagering game system, according to some embodiments. The flow of 700 will be described with reference to the example system architecture of FIG. 5. The flow diagram begins at block 702.

At block 702, the gaming machine 560 detects a fiducial marker in one or more images captured by a camera of the gaming machine 560. As described above, in one example, a player positions a game ticket (or other physical object, e.g., mobile phone) comprising a fiducial marker (e.g., fiducial marker 124) in the field of vision of the camera (e.g., camera 165). The camera captures video of objects in the field of vision of the camera including the fiducial marker. In one implementation, the image processing unit 562 of the gaming machine 560 detects the fiducial marker in one of the objects captured in the video. In one implementation, the fiducial marker can include a fiducial code and a bounding indicator (e.g., fiducial code 125 and bounding indicator 126). After block 702, the flow continues at block 704.

At block 704, the gaming machine 560 determines the orientation of the fiducial marker. In one implementation, the image processing unit 562 detects the bounding indicator of the fiducial marker to determine the orientation of the fiducial marker. In one example, the bounding indicator can comprise a bounding square. In this example, the image processing unit 562 can determine the orientation of the fiducial marker by performing measurements on the location of the corners of the bounding square and the angles of the corners of the square. The image processing unit 562 can determine the location of the corners of the bounding square and determine the angles of the corners of the square, and comparing them to a reference, in order to determine the orientation of the fiducial marker. It is noted, however, that in other implementations the gaming machine 560 can determine the orientation of the fiducial marker by other methods. It is further noted that in other implementations the bounding indicator can be other types of indicators besides a bounding square, as long as the orientation of the fiducial marker can be determined from the indicator. In some implementations, the image processing unit 562 can also use the bounding indicator to help identify the location of the fiducial code. The bounding indicator can be larger or otherwise be easier to detect with machine vision than the fiducial code. In this example, once the bounding indicator is detected, the gaming machine 560 can focus within or around the bounding indicator to detect the fiducial code. In other implementations, the gaming machine 560 can use the fiducial code and/or other metadata embedded within the fiducial marker to determine the orientation of the fiducial marker. After block 704, the flow continues at block 706.

At block 706, the gaming machine 560 detects the fiducial code embedded within the fiducial marker. In one implementation, the image processing unit 562 detects the fiducial code within the fiducial marker in one or more of the images captured by the camera. As described above, in some examples, the fiducial code may include any type of optical machine-readable code or representation of data, for example, a 1D code (e.g., linear barcode), a 2D code (e.g., a matrix of dots and geometric shapes), text, geometric patterns, etc., or a combination thereof, that can be used to identify which augmented reality object to render. The fiducial code may also include additional metadata and other information associated with the fiducial marker, e.g., a serial number embedded in the fiducial code to track when the player uses the fiducial marker, and/or a bonus indicator embedded in the fiducial code to indicate that the player should be awarded a bonus credit for using the fiducial marker. After block 706, the flow continues at block 708.

At block 708, the gaming machine 560 provides information indicating the fiducial code and information indicating the fiducial marker orientation to the wagering game server 550 via the communications network 555. In one implementation, the game management unit 564 provides the fiducial code information and the fiducial marker orientation information to the wagering game server 550. The wagering game server 550 can use this information to identify an augmented reality object associated with the fiducial code, determine attributes about the augmented reality object, and composite the augmented reality object with the wagering game content that is being provided to the gaming machine 560, as will be further described below with reference to FIG. 8. It is noted, however, that in some implementations, the augmented reality object unit 568 of the gaming machine 560 can be configured to perform the compositing operations. In other words, the gaming machine 560 can receive the wagering game content and the rendered augmented reality object, and the gaming machine 560 can composite the video of the fiducial marker and the augmented reality object with the wagering game content. After block 708, the flow continues at block 710.

At block 710, the gaming machine 560 receives the wagering game content composited with the augmented reality object from the wagering game server 550 via the communications network 555. In one implementation, the game management unit 564 receives the wagering game content composited with the augmented reality object from the wagering game server 550. After block 710, the flow continues at block 712.

At block 712, the gaming machine 560 presents the wagering game content composited with the augmented reality object on a display device of the gaming machine 560. In one implementation, the game management unit 564 causes the presentation unit 566 to present the wagering game content composited with the augmented reality object on the display device. After block 712, the flow ends.

FIG. 8 is a flow diagram (“flow”) 800 illustrating operations for implementing augmented reality in a wagering game system, according to some embodiments. The flow of 800 will be described with reference to the example system architecture of FIG. 5. The flow diagram begins at block 802.

At block 802, the wagering game server 550 provides, via a communications network 555, wagering game content to a gaming machine 560 to initiate a wagering game session. In one implementation, the game management unit 552 provides (e.g., streams) wagering game content to the gaming machine 560 to initiate a wagering game session. The gaming machine 560 presents the wagering game content on a display device (e.g., an LCD screen) of the gaming machine 560. The gaming machine 560 uses a video capture device and image processing mechanism to detect a fiducial marker and determine fiducial code information and fiducial marker orientation information, as was described above with reference to FIG. 7. After block 802, the flow continues at block 804.

At block 804, the wagering game server 550 receives, from the gaming machine 560, fiducial marker information including fiducial code information and fiducial marker orientation information. In one implementation, the game management unit 552 receives information identifying the fiducial code that was detected by the gaming machine 560, and information indicating the orientation of the fiducial marker. The game management unit 552 then provides this information to the augmented reality unit 556. After block 804, the flow continues at block 806.

At block 806, the wagering game server 550 determines the augmented reality object associated with the fiducial code. In one implementation, the augmented reality unit 556 maintains a data store (e.g., a look-up table) that associates fiducial codes to augmented reality objects. In this implementation, after receiving the fiducial code information, the augmented reality unit 556 accesses the data store to determine which augmented reality object is associated with the fiducial code. For instance, in the example of FIG. 2, the augmented reality unit 556 determines that the augmented reality object associated with the fiducial code is an avatar with a flashlight. In some implementations, the augmented reality unit 556 may also determine whether the augmented reality object can be used at the gaming machine 560. For example, the augmented reality unit 556 can determine what wagering games are available to be played at the gaming machine 560, and determine whether the augmented reality object can be used to play at least one of these wagering games. In one implementation, the data store that is maintained by the augmented reality unit 556 can also specify the wagering games that can be played using the augmented reality object. In one implementation, the wagering game server 550 can cause the gaming machine 560 to notify the player when a fiducial marker is incompatible with the wagering games that are available at the gaming machine 560. In this case, the wagering game server 550 can also indicate which wagering games and/or gaming machines in the casino are compatible with the fiducial marker. After block 806, the flow continues at block 808.

At block 808, the wagering game server 550 determines how to render the augmented reality object based on the fiducial code and the orientation of the fiducial marker. In one implementation, the augmented reality unit 556 can determine attributes of the augmented reality object, e.g., determine movement, orientation, composition, etc. of the augmented reality object based on the orientation of the fiducial marker and/or metadata embedded within the fiducial code. In one example, the fiducial marker orientation information can indicate the location of the corners of a bounding indicator of the fiducial marker and also the angles of the corners of the bounding indicator. The augmented reality unit 556 can compare this angular and orientation information to a reference to determine attributes of the augmented reality object. In another example, the gaming machine 560 can compare the angular and orientation information to a reference and provide the comparison results to the wagering game server 550 as part of the fiducial marker orientation information. In some implementations, the augmented reality unit 556 can determine the orientation and the movement of the augmented reality object based, at least in part, on how the angular and orientation information compares to the reference. For example, when the augmented reality unit 556 detects that the corners of the bounding indicator are at a certain location (with respect to a reference point), the augmented reality unit 556 can determine that the player has rotated the fiducial marker a certain amount in a particular direction. This detected action by the player can control the orientation and the movement of the augmented reality object within the wagering game. In another example, the augmented reality unit 556 can determine whether the player has tilted (and how much and in what direction) the fiducial marker based on the angles of the corners of the bounding indicator. This detected action of the fiducial marker can also control the orientation and the movement of the augmented reality object within the wagering game. In some implementations, characteristics of the movements and/or composition of the augmented reality object may be also determined based on metadata embedded within the fiducial code. After block 808, the flow continues at block 810.

At block 810, the wagering game server 550 composites the augmented reality object with the wagering game content that is being provided to the gaming machine 560. In some instances, compositing can include combining visual elements from separate sources into single images, e.g., one or more images that comprise a video stream. In some implementation, the augmented reality unit 556 composites video of the fiducial marker and the augmented reality object with the wagering game content. For example, the augmented reality unit 556 may composite video of the fiducial marker and the augmented reality object with the wagering game content such that the augmented reality object becomes a wagering game element within the wagering game and is controllable by the player. Furthermore, the augmented reality unit 556 can use the fiducial marker as a reference point when performing the compositing operations. For example, the augmented reality unit 556 can determine how to blend the video of the fiducial marker with the video of the augmented reality object based on the bounding indicator of the fiducial marker. For example, the augmented reality unit 556 can blend the video of the fiducial marker with the video of the augmented reality object such that the augmented reality object is rendered within the bounding indicator, or within a predetermined distance from the border of the bounding indicator. It is noted, however, that in other implementations the augmented reality unit 556 can composite the video of the fiducial marker and the augmented reality object with the wagering game content by other techniques. After block 810, the flow continues at block 812.

At block 812, the wagering game server 550 provides the wagering game content composited with the augmented reality object to the gaming machine 560 via the network 555 for presentation on the display device of the gaming machine 560. In one implementation, the game management unit 552 provides (e.g., streams) the wagering game content composited with the augmented reality object to the gaming machine 560. After block 812, the flow continues at FIG. 9.

FIG. 9 is a flow diagram (“flow”) 900 illustrating operations for using the fiducial marker and the augmented reality object to interact with the wagering game content in a wagering game system, according to some embodiments. The flow of 900 will be described with reference to the example system architecture of FIG. 5. The flow diagram, which is a continuation from FIG. 8, begins at block 902.

In block 902, the wagering game server 550 receives, from the gaming machine 560, orientation information for a fiducial marker associated with an augmented reality object composited with the wagering game content. For example, the game management unit 552 receives the fiducial marker orientation information and then provides this information to the augmented reality unit 556. After block 902, the flow continues at block 904.

At block 904, the wagering game server 550 determines whether the fiducial marker orientation information indicates a change in the orientation of the fiducial marker. In one implementation, the orientation of the fiducial marker can change when the player can rotates, tilts, or otherwise change the orientation of the fiducial mark (while the fiducial marker is positioned in the field of vision of the camera) to control various attributes of the augmented reality object during game play. For example, modifying the orientation of the fiducial marker can control the movement, modify the orientation, change the composition, etc. of the augmented reality object within the wagering game content. In some examples, modifying the orientation or movement of the augmented reality object can also control various aspects of the wagering game content so that the player can interact with the wagering game via the fiducial marker and augmented reality object. After block 904, the flow continues at block 906.

At block 906, if the wagering game server 550 detects a change in the orientation of the fiducial marker, the flow continues at block 908. Otherwise, the flow continues at block 910.

At block 908, the wagering game server 550 modifies one or more attributes of the augmented reality object composited with the wagering game content based on the fiducial marker orientation information received from the gaming machine 560. For example, as was described above, the augmented reality unit 556 can modify various attributes of the augmented realty object, e.g., the movement, the orientation, the composition, etc. of the augmented reality object during game play. After block 908, the flow continues at block 912.

At block 910, if the wagering game server 550 does not detect a change in the orientation of the fiducial marker, the wagering game server 550 maintains the attributes of the augmented reality object. For example, the augmented reality unit 556 may maintain the movement or the orientation of the augmented reality object within the wagering game. For instance, in the example of FIG. 2, if the avatar with the flashlight is moving straight down the hallway with the flashlight extended directly in front of the avatar, the avatar continues to move down the hallway in the same manner within the wagering game. After block 910, the flow continues at block 912.

At block 912, the wagering game server 550 provides the wagering game content composited with the modified augmented reality object to the gaming machine 560 for presentation on the display device. For example, the game management unit 552 provides (e.g., streams) the wagering game content composited with the augmented reality object to the gaming machine 560 via the network 555. Depending on whether a change in the orientation of the fiducial marker was detected, the game management unit 552 may provide a modified or unmodified augmented reality object composited within the wagering game content. After block 912, the flow loops back to block 902.

In some implementations, a second fiducial marker can be used to interact with the augmented reality object composited with the wagering game content. The gaming machine 560 can detect the second fiducial code positioned within the field of vision of the camera of the gaming machine 560. The player may position the second fiducial marker within the field of vision of the camera to interact with the augmented reality object and the wagering game content, e.g., to control the orientation and movements of the augmented reality object within the wagering game content. For example, the second fiducial marker can be a physical cube with six different fiducial codes (one fiducial code on each face of the cube). The player can control one or more attributes of the augmented reality object associated with the first fiducial marker based on which of the six fiducial codes on the second fiducial marker is positioned in the field of vision of the camera.

In some implementations, multiple players can use fiducial markers to play multi-player games or community games in a similar manner as described above with reference to FIGS. 1-9. In one example, each of the players can use a fiducial marker to control a separate augmented reality object within the wagering game. In another example, each of the players can use a fiducial marker to control one or more common augmented reality objects within the wagering game.

In some implementations, in addition to compositing the video of the fiducial marker and the augmented reality object with the wagering game content (e.g., see FIGS. 1-9), the wagering game server 550 (or the gaming machine 560) can composite video of other objects in the scene captured by the camera of the gaming machine 560 with the fiducial marker, the augmented reality object and the wagering game content. In one implementation, an online wagering game system can offer players a selectable option to composite video of objects in the scene captured by the camera with the fiducial marker, the augmented reality object and the wagering game content. For example, a player may want to incorporate some of the objects in the player's room (or other environment) into the wagering game. The online wagering game system may also allow players to specify or select which objects that are captured by the camera to composite with the rest of the content.

It is noted that in other embodiments the wagering game system 500 can introduce augmented reality objects by other means instead of, or in addition to, fiducial markers. In some embodiments, instead of, or in addition to, the gaming machine 560 detecting a fiducial code within a fiducial marker (e.g., see FIGS. 1-4), the gaming machine 560 can detect a light pattern or a sequence of on/off light flashes that serve as a code for an augmented reality object. For example, the gaming machine 560 can include a light sensor (e.g., a camera) to detect a sequence of light flashes from a light emitter (e.g., one or more infrared LEDs, visual LEDs, etc.). Rather than encoding an augmented reality object identifier in a fiducial marker, the wagering game server 550 may provide a code to a player's device that is configured to generate a sequence of light flashes based on the received code. When the player positions the light-generating device in the field of vision of the light sensor on the gaming machine 560, the light sensor can detect the sequence of light flashes. The gaming machine 560 may then determine the augmented reality object associated with the code indicated by the sequence of light flashes. Furthermore, after compositing the associated augmented reality object with the wagering game content, the player can modify attributes, or otherwise manipulate the augmented reality object, during game play by moving the light-generating device positioned in the field of vision of the light sensor. For example, the gaming machine 560 can use the position of the LEDs, and other features of the device, and reference points to track the movement of the light-generating device. In one specific example, the light-generating device can be a light-generating magic wand that can be used by the player to control the wagering game content (including the augmented reality object) of a wagering game.

### Additional Example Operating Environments

This section describes example operating environments, systems and networks, and presents structural aspects of some embodiments.

### Wagering Game Machine Architecture

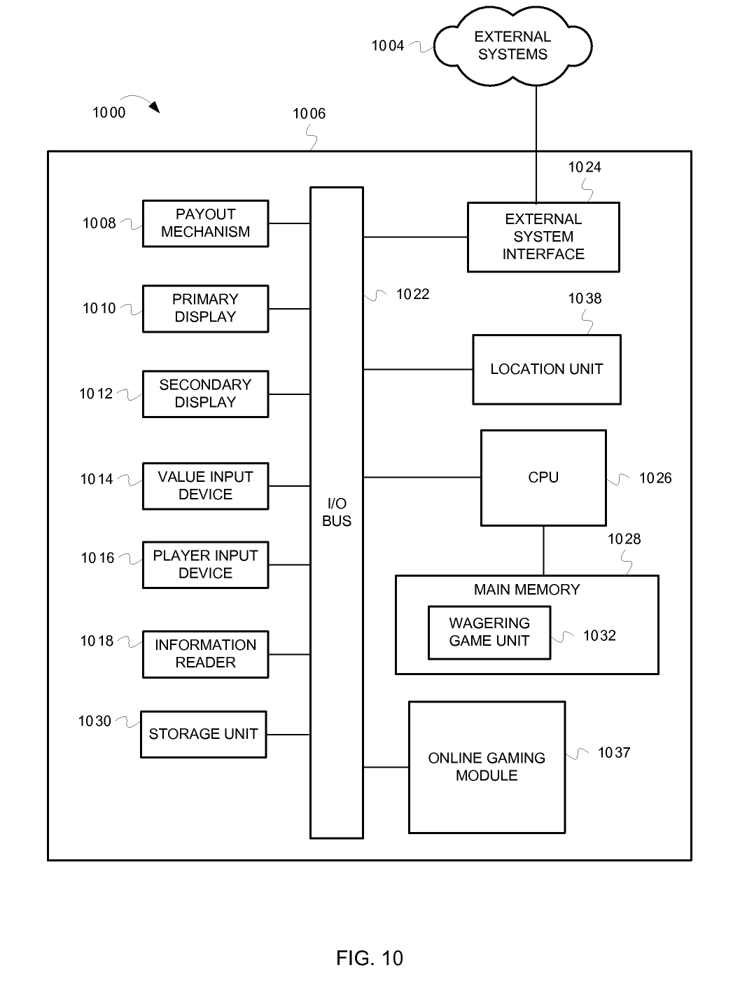

FIG. 10 is a conceptual diagram that illustrates an example of a wagering game machine architecture 1000, according to some embodiments. In FIG. 10, the wagering game machine architecture 1000 includes a wagering game machine 1006, which includes a central processing unit (CPU) 1026 connected to main memory 1028. The CPU 1026 can include any suitable processor, such as an Intel® Pentium processor, Intel® Core 2 Duo processor, AMD Opteron™ processor, or UltraSPARC processor. The main memory 1028 includes a wagering game unit 1032. In some embodiments, the wagering game unit 1032 can present wagering games, such as video poker, video black jack, video slots, video lottery, reel slots, etc., in whole or part. The wagering game unit 1032 may also facilitate in detecting fiducial markers and process fiducial marker information to implementing augmented reality within wagering games, e.g., as described above with reference to FIGS. 1-9.

The CPU 1026 is also connected to an input/output (“I/O”) bus 1022, which can include any suitable bus technologies, such as an AGTL+ frontside bus and a PCI backside bus. The I/O bus 1022 is connected to a payout mechanism 1008, primary display 1010, secondary display 1012, value input device 1014, player input device 1016, information reader 1018, and storage unit 1030. The player input device 1016 can include the value input device 1014 to the extent the player input device 1016 is used to place wagers. The I/O bus 1022 is also connected to an external system interface 1024, which is connected to external systems 1004 (e.g., wagering game networks). The external system interface 1024 can include logic for exchanging information over wired and wireless networks (e.g., 802.11g transceiver, Bluetooth transceiver, Ethernet transceiver, etc.)

The I/O bus 1022 is also connected to a location unit 1038. The location unit 1038 can create player information that indicates the wagering game machine's location/movements in a casino. In some embodiments, the location unit 1038 includes a global positioning system (GPS) receiver that can determine the wagering game machine's location using GPS satellites. In other embodiments, the location unit 1038 can include a radio frequency identification (RFID) tag that can determine the wagering game machine's location using RFID readers positioned throughout a casino. Some embodiments can use GPS receiver and RFID tags in combination, while other embodiments can use other suitable methods for determining the wagering game machine's location. Although not shown in FIG. 10, in some embodiments, the location unit 1038 is not connected to the I/O bus 1022.

In some embodiments, the wagering game machine 1006 can include additional peripheral devices and/or more than one of each component shown in FIG. 10. For example, in some embodiments, the wagering game machine 1006 can include multiple external system interfaces 1024 and/or multiple CPUs 1026. In some embodiments, any of the components can be integrated or subdivided.

In some embodiments, the wagering game machine 1006 includes an online gaming module 1037. The online gaming module 1037 can process communications, commands, or other information, where the processing can control and present online wagering games. In some embodiments, the online gaming module 1037 can work in concert with the wagering game unit 1032, and can perform any of the operations described above.

Furthermore, any component of the wagering game machine 1006 can include hardware, firmware, and/or machine-readable media including instructions for performing the operations described herein.

### Example Wagering Game Machines

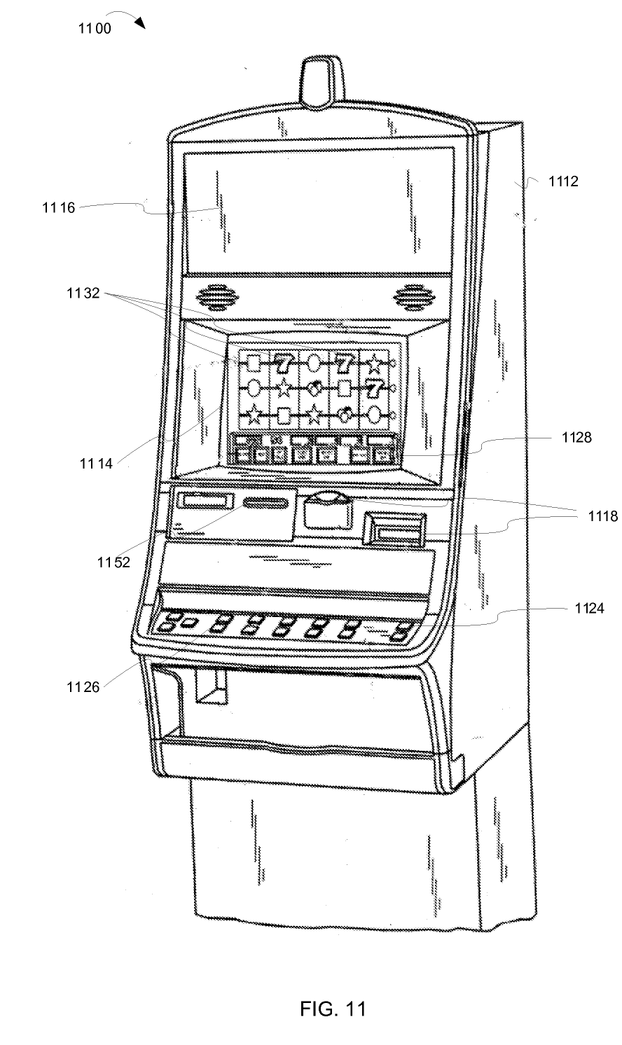

FIG. 11 is a perspective view of a wagering game machine, according to example embodiments. Referring to FIG. 11, a wagering game machine 1100 is used in gaming establishments, such as casinos. In some embodiments, the wagering game machine 1100 can implement the functionality described above in FIGS. 1-9 for implementing augmented reality within wagering game systems.

According to embodiments, the wagering game machine 1100 can be any type of wagering game machine and can have varying structures and methods of operation. For example, the wagering game machine 1100 can be an electromechanical wagering game machine configured to play mechanical slots, or it can be an electronic wagering game machine configured to play video casino games, such as blackjack, slots, keno, poker, blackjack, roulette, etc.

The wagering game machine 1100 comprises a housing 1112 and includes input devices, including value input devices 1118 and a player input device 1124. For output, the wagering game machine 1100 includes a primary display 1114 for displaying information about a basic wagering game. In some implementations, the primary display 1114 can also display information about a bonus wagering game and a progressive wagering game. The wagering game machine 1100 also includes a secondary display 1116 for displaying bonus wagering games, wagering game events, wagering game outcomes, and/or signage information. While some components of the wagering game machine 1100 are described herein, numerous other elements can exist and can be used in any number or combination to create varying forms of the wagering game machine 1100.

The value input devices 1118 can take any suitable form and can be located on the front of the housing 1112. The value input devices 1118 can receive currency and/or credits inserted by a player. The value input devices 1118 can include coin acceptors for receiving coin currency and bill acceptors for receiving paper currency. Furthermore, the value input devices 1118 can include ticket readers or barcode scanners for reading information stored on vouchers, cards, or other tangible portable storage devices. The vouchers or cards can authorize access to central accounts, which can transfer money to the wagering game machine 1100.

The player input device 1124 comprises a plurality of push buttons on a button panel 1126 for operating the wagering game machine 1100. In addition, or alternatively, the player input device 1124 can comprise a touch screen 1128 mounted over the primary display 1114 and/or secondary display 1116.

The various components of the wagering game machine 1100 can be connected directly to, or contained within, the housing 1112. Alternatively, some of the wagering game machine's components can be located outside of the housing 1112, while being communicatively coupled with the wagering game machine 1100 using any suitable wired or wireless communication technology.

The operation of the basic wagering game can be displayed to the player on the primary display 1114. The primary display 1114 can also display a bonus game associated with the basic wagering game. The primary display 1114 can include a cathode ray tube (CRT), a high resolution liquid crystal display (LCD), a plasma display, light emitting diodes (LEDs), or any other type of display suitable for use in the wagering game machine 1100. Alternatively, the primary display 1114 can include a number of mechanical reels to display the outcome. In FIG. 11, the wagering game machine 1100 is an “upright” version in which the primary display 1114 is oriented vertically relative to the player. Alternatively, the wagering game machine can be a “slant-top” version in which the primary display 1114 is slanted at about a thirty-degree angle toward the player of the wagering game machine 1100. In yet another embodiment, the wagering game machine 1100 can exhibit any suitable form factor, such as a free standing model, bartop model, mobile handheld model, or workstation console model.

A player begins playing a basic wagering game by making a wager via the value input device 1118. The player can initiate play by using the player input device's buttons or touch screen 1128. The basic game can include arranging a plurality of symbols along a payline 1132, which indicates one or more outcomes of the basic game. Such outcomes can be randomly selected in response to player input. At least one of the outcomes, which can include any variation or combination of symbols, can trigger a bonus game.

In some embodiments, the wagering game machine 1100 can also include an information reader 1152, which can include a card reader, ticket reader, bar code scanner, RFID transceiver, or computer readable storage medium interface. In some embodiments, the information reader 1152 can be used to award complimentary services, restore game assets, track player habits, etc.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A computer-implemented method comprising:
detecting, at a gaming machine, a fiducial marker in one or more images captured by an image capture device of the gaming machine;
determining an orientation of the fiducial marker;
detecting a fiducial code embedded within the fiducial marker;
providing, via a communications network, fiducial code information and fiducial marker orientation information to a wagering game server to identify an augmented reality object associated with the fiducial code and determine attributes of the augmented reality object;
receiving, via the communications network, wagering game content and the augmented reality object from the wagering game server;
incorporating the augmented reality object within the wagering game content; and
presenting the wagering game content comprising the augmented reality object on a display device of the gaming machine.

2. The method of claim 1, wherein said detecting a fiducial marker comprises capturing one or more images of objects positioned in a field of vision of the image capture device of the gaming machine, and detecting the fiducial marker located within one of the objects captured in one or more of the images.

3. The method of claim 1, wherein said determining an orientation of the fiducial marker comprises detecting a bounding indicator embedded within the fiducial marker, performing measurements on the bounding indicator, and determining the orientation of the fiducial marker based on the measurements performed on the bounding indicator.

4. The method of claim 3, wherein said performing measurements on the bounding indicator comprises determining angular and orientation information associated with the bounding indicator with respect to one or more reference points.

5. The method of claim 1, wherein said incorporating the augmented reality object within the wagering game content comprises compositing the augmented reality object and video of the fiducial marker with the wagering game content.

6. The method of claim 1, wherein the augmented reality object is a three-dimensional (3D) augmented reality object.

7. The method of claim 1, wherein said detecting a fiducial code embedded within the fiducial marker comprises detecting an optical machine-readable representation of data embedded within the fiducial marker.

8. A computer-implemented method comprising:
providing, via a communications network, wagering game content from a wagering game server to a gaming machine to initiate a wagering game session;
receiving, at the wagering game server, information associated with a fiducial marker detected by the gaming machine, said information comprising information associated with a fiducial code embedded within the fiducial marker and information indicating an orientation of the fiducial marker;
identifying an augmented reality object associated with the fiducial code;
determining attributes associated with the augmented reality object based on the orientation of the fiducial marker;
incorporating the augmented reality object within the wagering game content; and
providing, via the communications network, the wagering game content comprising the augmented reality object to the gaming machine for presentation on a display device of the gaming machine.

9. The method of claim 8, wherein said determining attributes associated with the augmented reality object based on the orientation of the fiducial marker comprises determining one or more of movements, orientation, and composition of the augmented reality object within the wagering game content based on the orientation of the fiducial marker.

10. The method of claim 8, wherein said incorporating the augmented reality object within the wagering game content comprises compositing the augmented reality object and video of the fiducial marker with the wagering game content.

11. The method of claim 8, wherein said identifying an augmented reality object associated with the fiducial code comprises accessing a data store comprising associated fiducial codes and augmented reality objects, searching for the fiducial code within the data store, and identifying the augmented reality object associated with the fiducial code.

12. The method of claim 8, further comprising:
receiving information indicating the orientation of the fiducial marker from the gaming machine;
determining that the orientation of the fiducial marker has changed; and
modifying the attributes of the augmented reality object based on the orientation of the fiducial marker.

13. The method of claim 8, further comprising:
detecting a game event in a wagering game being played by a player during the wagering game session at the gaming machine;
awarding an augmented reality opportunity during the wagering game session based on the game event;
determining a fiducial marker including a fiducial code and a bounding indicator associated the augmented reality opportunity; and
causing the fiducial marker to be provided to the player.

14. The method of claim 13, wherein said causing the fiducial marker to be provided to the player comprises one of causing the gaming machine to print the fiducial marker, emailing the fiducial marker to the player, and texting the fiducial marker to the player.

15. The method of claim 8, further comprising:
receiving, from the gaming machine, information associated with a second fiducial marker detected by the gaming machine, said information comprising information associated with a second fiducial code embedded within the second fiducial marker and information indicating an orientation of the second fiducial marker; and
modifying the attributes of the augmented reality object based on the second fiducial code and the orientation of the second fiducial marker.

16. A wagering game server comprising:
a game management unit configured to provide, via a communications network, wagering game content to a gaming machine to initiate a wagering game session, and configured to:
receive, from the gaming machine, information associated with a fiducial marker detected by the gaming machine, said information comprising information associated with a fiducial code embedded within the fiducial marker and information indicating an orientation of the fiducial marker; and
an augmented reality unit configured to identify an augmented reality object associated with the fiducial code, and configured to:
determine attributes associated with the augmented reality object based on the orientation of the fiducial marker;
composite the augmented reality object with the wagering game content; and
cause the game management unit to provide, via the communications network, the wagering game content composited with the augmented reality object to the gaming machine.

17. The wagering game server of claim 16, wherein the augmented reality unit configured to determine attributes associated with the augmented reality object comprises the augmented reality unit configured to determine one or more of movements, orientation, and composition of the augmented reality object within the wagering game content based on the orientation of the fiducial marker.

18. The wagering game server of claim 16, wherein the augmented reality unit is further configured to:
determining that the orientation of the fiducial marker has changed; and
modifying the attributes of the augmented reality object based on the orientation of the fiducial marker.

19. The wagering game server of claim 16, wherein:
the game management unit is further configured to detect a game event in a wagering game being played by a player during the wagering game session at the gaming machine and configured to award an augmented reality opportunity during the wagering game session based on the game event; and
the augmented reality unit is further configured to determine a fiducial marker including a fiducial code and a bounding indicator associated the augmented reality opportunity and configured to cause the game management unit to provide the fiducial marker to the player.

20. A wagering game machine comprising:
means for capturing one or more images of objects positioned in a field of vision of an image capture device of the wagering game machine;
means for detecting a fiducial marker located in one of the objects captured in one or more of the images;
means for detecting a bounding indicator embedded within the fiducial marker;
means for performing measurements on the bounding indicator;
means for determining an orientation of the fiducial marker based on the measurements performed on the bounding indicator;
means for detecting a fiducial code embedded within the fiducial marker;
means for providing fiducial code information and fiducial marker orientation information to a wagering game server to identify an augmented reality object associated with the fiducial code;
means for receiving wagering game content and the augmented reality object from the wagering game server;
means for compositing the augmented reality object with the wagering game content; and
means for presenting the wagering game content composited with the augmented reality object.

21. The wagering game machine of claim 20, wherein said means for detecting the fiducial code embedded within the fiducial marker comprises means for detecting an optical machine-readable representation of data embedded within the fiducial marker.

22. The wagering game machine of claim 20, wherein said means for performing measurements on the bounding indicator comprises means for determining angular and orientation information associated with the bounding indicator with respect to one or more reference points.

23. One or more machine-readable storage media, having instructions stored therein, which, when executed by one or more processors causes the one or more processors to perform operations that comprise:
determining wagering game content to provide to a gaming machine via a communications network to initiate a wagering game session;
identifying an augmented reality object associated with a fiducial marker detected by the gaming machine based, at least in part, on information associated with the fiducial marker received from the gaming machine, said information comprising information associated with a fiducial code embedded within the fiducial marker and information indicating an orientation of the fiducial marker;
determining attributes associated with the augmented reality object based on the orientation of the fiducial marker;
compositing the augmented reality object with the wagering game content; and
providing, via the communications network, the wagering game content composited with the augmented reality object to the gaming machine for presentation on the gaming machine.

24. The machine-readable storage media of claim 23, wherein the operations further comprise determining that the orientation of the fiducial marker has changed and modifying the attributes of the augmented reality object based on the orientation of the fiducial marker.

25. The machine-readable storage media of claim 23, wherein said operations for identifying an augmented reality object comprise operations for accessing a data store comprising associated fiducial codes and augmented reality objects, searching for the fiducial code within the data store, and identifying the augmented reality object associated with the fiducial code.
